(19) United States
(12) Patent Application Publication
(10) Pub. No.: US 2016/0056536 A1
(43) Pub. Date: Feb. 25, 2016

(54) Electromagnetic Wave Absorbing Sheet and Antenna Module Having Same

(71) Applicant: AMOTECH CO., LTD., Incheon (KR)

(72) Inventors: Jong-Ho Park, Gyeonggi-do (KR); Ki-Sang Lim, Incheon (KR); Eul-Young Jung, Incheon (KR); Hyung-Il Baek, Gyeonggi-do (KR); Beom-Jin Kim, Gyeonggi-do (KR)

(73) Assignee: AMOTECH CO., LTD., Incheon (KR)

(21) Appl. No.: 14/768,156

(22) PCT Filed: Feb. 13, 2014
(86) PCT No.: PCT/KR2014/001178

§ 371 Date: Oct. 23, 2015

(30) Foreign Application Priority Data
Feb. 15, 2013 (KR) 10-2013-0016265
Feb. 12, 2014 (KR) 10-2014-0016056

(51) Int. Cl. H01Q 1/52; H01Q 7/04; H02J 7/02

(52) U.S. Cl. CPC H01Q 1/526; H02J 7/025; H01Q 7/04

(57) ABSTRACT

This invention relates to an electromagnetic wave absorption sheet and an antenna module having the same, wherein a first electromagnetic wave absorption sheet and a second electromagnetic wave absorption sheet are stacked to overlap each other on one surface of an antenna unit, and the first and the second electromagnetic wave absorption sheet have different permeabilities, thereby simplifying the assembly process, significantly decreasing the defect of an outer appearance, increasing productivity, and enhancing both near field wireless communication performance and wireless power charging performance.

### TECHNICAL FIELD

The present invention relates to an electromagnetic wave absorption sheet and an antenna module having the same, and more particularly, to an electromagnetic wave absorption sheet, which is enhanced in both near field communication performance and wireless power charging performance, and to an antenna module having the same.

This application claims the benefit of Korean Patent Application Nos. KR 10-2013-0016265, filed Feb. 15, 2013 and KR 10-2014-0016056, filed Feb. 12, 2014, which are hereby incorporated by reference in their entirety into this application.

### BACKGROUND ART

Near field communication (NFC) is a kind of radio frequency identification technology for transferring data between devices in close proximity to one another in a non-contact manner using a frequency of about 13.56 MHz. NFC is widely utilized for payment functions, transmission of product information in supermarkets or general stores or travel information for visitors, traffic access control locks, etc.

Recently, the markets for portable devices, including tablets, smart phones, etc., have rapidly expanded. Portable devices typically include functions of information exchange between devices, payment, ticketing, and search, by the use of near field communication. Therefore, the demand for antenna modules used for near field communication systems is increasing.

Wireless power charging (WPC) technology, which is a power charging process that uses radio waves, mainly adopts a magnetic induction method. A magnetic induction-type wireless power charging process is a wireless power charging technique that uses magnetic induction. As the amount of time that smart phones are used gradually increases, battery packs thereof have to be more frequently charged, which is undesirable. Accordingly, attempts have been made to provide the antenna module with wireless power charging functionality, particularly for use in smart phones.

An antenna module having NFC and wireless power charging functionalities includes an electromagnetic wave absorption sheet for preventing antenna performance from being deteriorated by electromagnetic waves generated from battery packs and external electromagnetic waves, and also for blocking electromagnetic waves generated by devices.

In order to improve the electromagnetic wave absorption performance of the electromagnetic wave absorption sheet, it should be made of a high dielectric material or should be formed to be thick. These days, the electromagnetic wave absorption sheet is provided in the form of a single layer, and there is a limitation on the thickness thereof, based on the trend whereby electronic products are manufactured to be small and slim.

With reference to FIG. 1, an electromagnetic wave absorption sheet 150 is disposed between the battery pack 120 of a portable device 110 and an antenna unit 140, and is attached to the antenna unit 140. Furthermore, the electromagnetic wave absorption sheet is provided in the form of a single layer including a first electromagnetic wave absorption sheet 160, having an opening for exposing the wireless power charging antenna pattern of the antenna unit 14, and a second electromagnetic wave absorption sheet 170, disposed at the opening of the first electromagnetic wave absorption sheet 160.

As illustrated in FIG. 1, in order to form the electromagnetic wave, absorption sheet 150 as a single layer, a perforation process is additionally required, in which the portion of the first electromagnetic wave absorption sheet 160 at which the wireless power charging antenna pattern is positioned is perforated. As such, the portion cut from the sheet in the perforation process is discarded, which is undesirable. Furthermore, the second electromagnetic wave absorption sheet 170 is disposed so as to be aligned with the opening in the first electromagnetic wave absorption sheet 160, and then the sheets are attached to the antenna unit 140. Moreover, in the assembly process, the second electromagnetic wave absorption sheet 170 and the first electromagnetic wave absorption sheet 160, which are attached to the antenna unit 140, may be misaligned, undesirably resulting in a poor outer appearance.

In an exemplary embodiment as illustrated in FIG. 2, unlike FIG. 1, in order to minimize the discarded portion of the first electromagnetic wave absorption sheet 160, the first electromagnetic wave absorption sheet 160 may be sectioned and attached to the antenna unit 240.

Specifically, an electromagnetic wave absorption sheet 250 includes a first electromagnetic wave absorption sheet 260, which is quadrisectioned, and a second electromagnetic wave absorption sheet 270 enclosed with the sectioned first electromagnetic wave absorption sheet 260. The second electromagnetic wave absorption sheet 270 and the first electromagnetic wave absorption sheet 260, which is quadrisectioned and is disposed to enclose the second electromagnetic wave absorption sheet 270, are attached to the antenna unit 240.

In the electromagnetic wave absorption sheet 250 of FIG. 2, the discarded portion of the first electromagnetic wave absorption sheet 260 is small, compared to the electromagnetic wave absorption sheet 150 of FIG. 1, thus minimizing the waste of raw material, but the number of attachment steps is large in the assembly process, undesirably increasing the likelihood of the generation of defects by workers.

### DISCLOSURE

### Technical Problem

The present invention has been made keeping in mind the aforementioned problems, and an object of the present invention is to provide an electromagnetic wave absorption sheet, which is enhanced in both near field communication performance and wireless power charging performance, and an antenna module having the same.

The present invention has been made keeping in mind the aforementioned problems, and an object of the present invention is to provide an electromagnetic wave absorption sheet, which is formed through a simple assembly process, thus realizing high productivity, low manufacturing cost, and high product operational reliability, and an antenna module having the same.

### Technical Solution

In order to accomplish the above objects, an embodiment of the present invention provides an antenna module, comprising: an antenna unit; a first electromagnetic wave absorption sheet disposed on one surface of the antenna unit; and a second electromagnetic wave absorption sheet disposed on one surface of the first electromagnetic wave absorption sheet such that the second electromagnetic wave absorption sheet at least partially overlaps the first electromagnetic wave absorption sheet.

In the present invention, the first electromagnetic wave absorption sheet and the second electromagnetic wave absorption sheet may be disposed between the antenna unit and the battery pack of a portable device.

In the present invention, the antenna unit may comprise: a wireless communication antenna pattern for near field wireless communication; a wireless power charging antenna pattern for wireless power charging; and a substrate on which the wireless communication antenna pattern and the wireless power charging antenna pattern are formed.

In the present invention, of the first electromagnetic wave absorption sheet and the second electromagnetic wave absorption sheet, one may function to increase wireless recognition performance, and the other may function to increase wireless power charging performance.

In addition, an embodiment of the present invention provides an electromagnetic wave absorption sheet, comprising: a first electromagnetic wave absorption sheet; and a second electromagnetic wave absorption sheet disposed on one surface of the first electromagnetic wave absorption sheet such that the second electromagnetic wave absorption sheet at least partially overlaps the first electromagnetic wave absorption sheet.

In the present invention, the first electromagnetic wave absorption sheet and the second electromagnetic wave absorption sheet may have different permeabilities.

In the present invention, the first electromagnetic wave absorption sheet and the second electromagnetic wave absorption sheet may be laminated in a mariner such that the entire surface of one is covered with the entire surface of the other.

In the present invention, the first electromagnetic wave absorption sheet and the second electromagnetic wave absorption sheet may have the same size and may be disposed so as to completely overlap each other.

In the present invention, the first electromagnetic wave absorption sheet or the second electromagnetic wave absorption sheet may be any one selected from among a carbon nanosheet containing carbon nanotubes or carbon nanoparticles, an amorphous sheet containing an amorphous alloy, a polymer sheet containing a magnetic powder, and a ferrite sheet.

In the present invention, the first electromagnetic wave absorption sheet may be any one selected from among a carbon nanosheet containing carbon nanotubes or carbon nanoparticles, an amorphous sheet containing an amorphous alloy, a polymer sheet containing a magnetic powder, and a ferrite sheet, and the second electromagnetic wave absorption sheet may be any one selected from among a carbon nanosheet containing carbon nanotubes or carbon nanoparticles, an amorphous sheet containing an amorphous alloy, a polymer sheet containing a magnetic powder, and a ferrite sheet, and may be different from a material of the first electromagnetic wave absorption sheet.

In the present invention, of the first electromagnetic wave absorption sheet and the second electromagnetic wave absorption sheet, one may be a polymer sheet containing a magnetic powder, and the other may be any one selected from among a carbon nanosheet containing carbon nanotubes or carbon nanoparticles, an amorphous sheet containing an amorphous alloy, a polymer sheet containing a magnetic powder, and a ferrite sheet.

### Advantageous Effects

According to the present invention, an antenna unit has a wireless communication antenna pattern and a wireless power charging antenna pattern, thus exhibiting both near field wireless communication performance and wireless power charging performance. An electromagnetic wave absorption sheet can be formed by overlapping a first electromagnetic wave absorption sheet and a second electromagnetic wave absorption sheet, thus simplifying the assembly process, significantly decreasing the defect of an outer appearance, and increasing productivity.

Also, according to the present invention, even when the thickness of the electromagnetic wave absorption sheet is not increased, high electromagnetic wave absorption efficiency can be attained, small and slim products can be manufactured, and manufacturing costs can be reduced.

Also, according to the present invention, the first electromagnetic wave absorption sheet and the second electromagnetic wave absorption sheet have different permeabilities, and can thus absorb the corresponding electromagnetic waves in the frequency ranges of individual patterns, thereby improving the operational reliability of the antenna module.

### DESCRIPTION OF DRAWINGS

FIGS. 1 and 2 illustrate the mounting of conventional antenna modules on portable devices;

FIG. 3 illustrates the mounting of an antenna module for both wireless recognition and wireless power charging according to the present invention on a portable device;

FIG. 4 illustrates the antenna unit of FIG. 3; and

FIG. 5 is a graph illustrating the wireless power charging efficiencies of Comparative Example 1, Comparative Example 2, and Comparative Example 3 of Table 1.

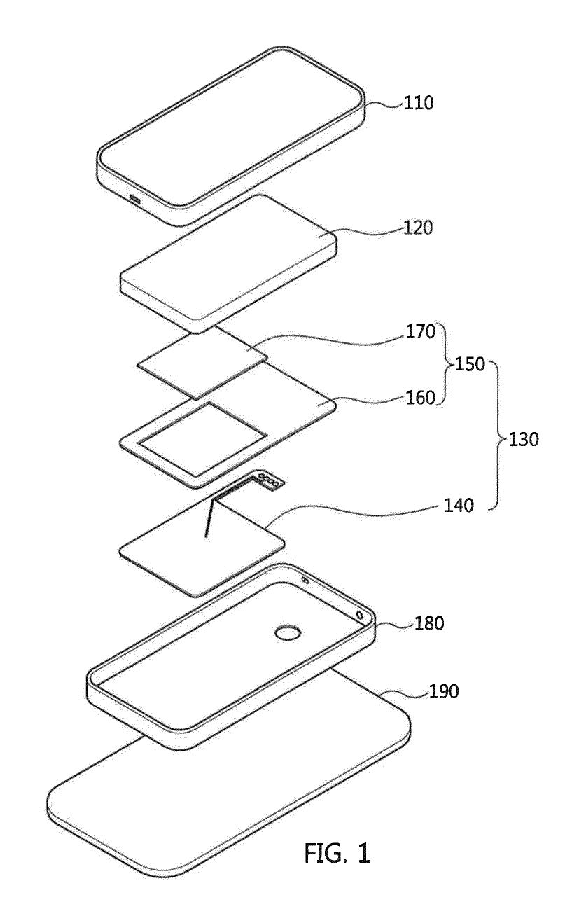

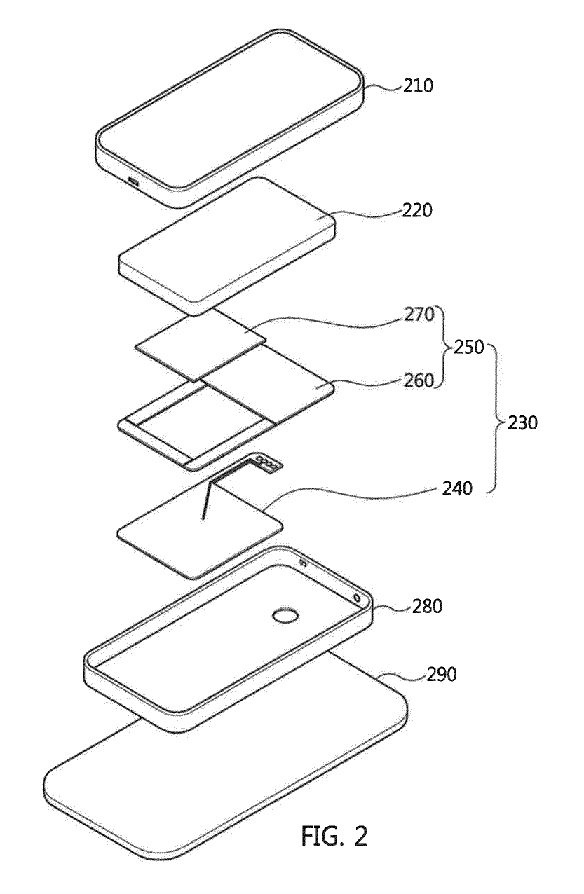

*Description of the Reference Numerals in the Drawings*

| | |
|---|---|
| 10: portable device | 20: battery pack |
| 30: antenna module | 40: antenna unit |

41: wireless communication pattern
43: wireless power charging pattern
45: substrate
46, 47, 48, 49: first to fourth terminals
50: electromagnetic wave absorption sheet
60: first electromagnetic wave absorption sheet
70: second electromagnetic wave absorption sheet
80: battery cover
90: charging pad

### BEST MODE

Hereinafter, a detailed description will be given of preferred embodiments of the present invention with reference to the accompanying drawings.

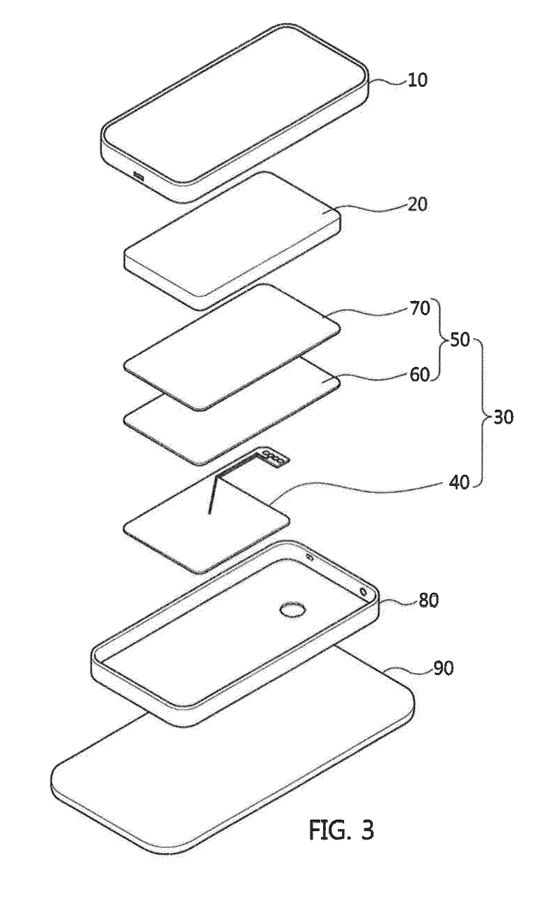

FIG. 3 illustrates the mounting of an antenna module according to the present invention on a portable device. With reference to FIG. 3, the antenna module according to the present invention, which is responsible for both wireless recognition and wireless power charging, is disposed on a portable device.

According to the present invention, the antenna module includes an antenna unit that is mounted on a portable device, and the antenna unit includes a near field wireless communication antenna and a wireless power charging antenna and thus exhibits near field wireless communication performance and wireless power charging performance.

Also, a first electromagnetic wave absorption sheet 60 is disposed on one surface of the antenna unit 40, and a second electromagnetic wave absorption sheet 70 is disposed on one surface of the first electromagnetic wave absorption sheet 60.

The second electromagnetic wave absorption sheet 70 is disposed on one surface of the first electromagnetic wave absorption sheet 60 such that they at least partially overlap each other. The first electromagnetic wave absorption sheet 60 and the second electromagnetic wave absorption sheet 70 are preferably laminated in a manner such that the entire surface of one is covered with the entire surface of the other. Furthermore, the first electromagnetic wave absorption sheet 60 and the second electromagnetic wave absorption sheet 70 have the same size as each other, and are thus disposed to completely overlap each other, thereby eliminating level differences due to different sizes, ultimately preventing the outer appearance from deteriorating due to level differences upon attachment, simplifying the assembly process, and increasing the convenience of the assembly process.

The first electromagnetic wave absorption sheet 60 is preferably the same size as the second electromagnetic wave absorption sheet 70. When the first electromagnetic wave absorption sheet 60 and the second electromagnetic wave absorption sheet 70 have the same size in this way, an antenna module having a totally uniform thickness may be manufactured.

Also, the first electromagnetic wave absorption sheet 60 may be smaller than the second electromagnetic wave absorption sheet 70, or the second electromagnetic wave absorption sheet 70 may be smaller than the first electromagnetic wave absorption sheet 60.

The antenna unit 40 is mounted on a portable device. For example, it is attached to the inner side of the battery cover 80 of the portable device.

The first electromagnetic wave absorption sheet 60 is attached to one surface of the antenna unit 40 by means of a bonding sheet, a piece of double-sided tape, or an adhesive, and the second electromagnetic wave absorption sheet 70 is attached to one surface of the first electromagnetic wave absorption sheet 60 by means of a bonding sheet, a piece of double-sided tape, or an adhesive.

One surface of the antenna unit 40 is the surface of the antenna unit 40 that is opposite the surface that is mounted on the portable device.

One surface of the first electromagnetic wave absorption sheet 60 is the surface of the first electromagnetic wave absorption sheet 60 that is opposite the surface that is attached to the antenna unit 60.

The antenna unit 40, the first electromagnetic wave absorption sheet 60, and the second electromagnetic wave absorption sheet 70 are configured to be stacked one on another.

The first electromagnetic wave absorption sheet 60 and the second electromagnetic wave absorption sheet 70 have different permeabilities.

According to the present invention, the antenna module is configured such that an electromagnetic wave absorption sheet 50 having two layers with different permeabilities is attached to the antenna unit 40. The electromagnetic wave absorption sheet 50 includes a sheet layer for improving wireless recognition performance and a sheet layer for improving wireless power charging performance.

According to the present invention, the electromagnetic wave absorption sheet 50 is attached to the battery pack 20 or the battery cover 80 that covers the battery pack 20 so that it is disposed between the battery pack 20 of the portable device 10 and the antenna unit 40. The battery cover 80 is detachably provided on the rear of the casing of the portable device 10 so that the battery pack 20 can be opened and closed.

The antenna module 30 has near field wireless communication and wireless power charging functionalities. The portable device 10 to which the antenna module 30 is attached may be charged under the condition that it is placed on a charging pad 90. The charging pad 90 may be configured such that an electric coil for generating an electromagnetic field is wound inside a plastic cover.

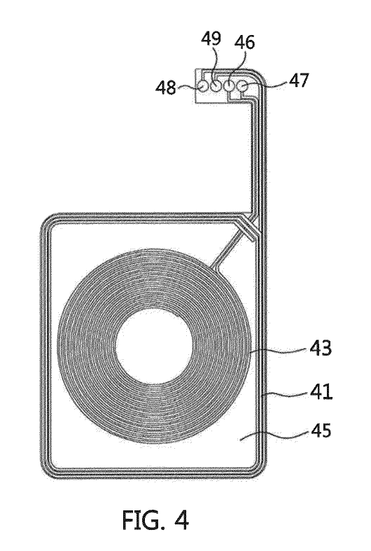

As illustrated in FIG. 4, the antenna unit 40 includes a wireless communication antenna pattern 41 for near field wireless communication, a wireless power charging antenna pattern 43 for wireless power charging, and a substrate 45 on which the wireless communication antenna pattern 41 and the wireless power charging antenna pattern 43 are formed.

The wireless communication antenna pattern functions as an antenna that resonates in the NFC frequency range.

The wireless communication antenna pattern 41 is illustratively provided in one or more lines having an approximately rectangular loop shape, particularly a shape wound several times from the inside to the outside in a plane or a shape wound several times from the outside to the inside in a plane. Such an antenna pattern is formed in a loop shape at the edge of the substrate 45, and the surface of the antenna pattern is plated with copper or nickel to thereby exhibit electrical properties.

The wireless power charging antenna pattern 43 acts as the wireless power charging antenna of the portable device.

The wireless power charging antenna pattern 43, which is spaced apart from the wireless communication antenna pattern 41, is configured such that a winding coil wound in a shape similar to a circle or oval is disposed at the center of the substrate 45, or such that a pattern coil wound in a shape similar to a circle or oval is disposed at the center of the substrate 45. The wireless power charging antenna pattern 43 is formed on the substrate 45 inside the wireless communication antenna pattern 41, which is formed at the edge of the substrate 45. The wireless power charging antenna pattern 43 receives induced current from the charging pad 90.

The antenna unit 40 may be configured such that the wireless communication antenna pattern 41 and the wireless power charging antenna pattern 43 are formed on a single substrate 45. Alternatively, the antenna unit 40 may be configured such that the wireless communication antenna pattern 41 and the wireless power charging antenna pattern 43 are formed on respective substrates 45 and the two substrates are stacked together.

In the latter case, when the substrate on which the wireless power charging antenna pattern 43 is formed and the substrate on which the wireless communication antenna pattern 41 is formed are stacked, the wireless power charging antenna pattern 43 and the wireless communication antenna pattern 41 may be connected to each other through via holes formed in the substrates.

The antenna unit 40 further includes a terminal part for electrical connection. The terminal part includes a first terminal 46 connected to one end of the wireless power charging antenna pattern 43, a second terminal 47 connected to the other end of the wireless power charging antenna pattern 43, a third terminal 48 connected to one end of the wireless communication antenna pattern 41, and a fourth terminal 49 connected to the other end of the wireless communication antenna pattern 41.

The wireless communication antenna pattern 41 and the wireless power charging antenna pattern 43 are connected to the terminals 46, 47, 48, 49 by a connection pattern (not shown).

The substrate 45 may be a flexible substrate or an insulating film. The insulating film may be exemplified by a polyimide film, and may also be any one selected from among a polyimide (PI) film, a polyethylene naphthalate (PEN) film, a polyethylene terephthalate (PET) film, a polycarbonate (PC) film, and a polystyrene sulfonate (PSS) film.

With reference to FIG. 3, the electromagnetic wave absorption sheet 50 includes the first electromagnetic wave absorption sheet 60, which is attached to the antenna unit 40, and the second electromagnetic wave absorption sheet 70, which is attached to the first electromagnetic wave absorption sheet 60. Specifically, the first electromagnetic wave absorption sheet 60 and the second electromagnetic wave absorption sheet 70 are stacked and then attached to the antenna unit 40.

The first electromagnetic wave absorption sheet 60 and the second electromagnetic wave absorption sheet 70 are used to block the electrical and magnetic influence of the battery pack 20 so that the communication performance of the wireless communication antenna is prevented from deteriorating and also to improve the wireless power charging performance of the wireless power charging antenna. The wireless communication antenna may be exemplified by an NFC antenna.

The use of the electromagnetic wave absorption sheet having a dual structure comprising the first electromagnetic wave absorption sheet 60 and the second electromagnetic wave absorption sheet 70, which are stacked, is intended to simplify the process of manufacturing the antenna module 30 according to the present invention and to decrease the thickness of the antenna module 30 while reducing the manufacturing cost.

As the electromagnetic wave absorption sheet, a ferrite sheet having a single layer may be used. In this case, the thickness of the ferrite sheet has to be greater than a preset thickness in order to increase the recognition distance of the wireless power charging antenna upon wireless power charging, and additionally, the ferrite sheet is preferably thick in order to ensure sufficient wireless power charging performance.

If the electromagnetic wave absorption sheet is thick, the total thickness of the antenna module is increased, undesirably resulting in thick portable device products. Furthermore, significant additional costs are incurred in order to increase the thickness of the electromagnetic wave absorption sheet.

In particular, when the ferrite sheet is used as the electromagnetic wave absorption sheet, it has to be formed to be thick, thus remarkably increasing the manufacturing cost.

The electromagnetic wave absorption sheet 50 is disposed between the battery pack 20 and the antenna unit 40 to thus absorb reaction flux from the metal surface of the battery pack 20, thereby enabling the antenna unit 40 to efficiently send and receive radio waves.

One of the first electromagnetic wave absorption sheet 60 and the second electromagnetic wave absorption sheet 70 is used to prevent the performance of the wireless power charging antenna from deteriorating.

The other of the first electromagnetic wave absorption sheet 60 and the second electromagnetic wave absorption sheet 70 is used to prevent the performance of the wireless communication antenna from deteriorating.

The first electromagnetic wave absorption sheet 60 and the second electromagnetic wave absorption sheet 70 have different permeabilities depending on the end use and application, and thus the permeability ranges thereof are set so as to shield electromagnetic waves.

The first electromagnetic wave absorption sheet 60 and the second electromagnetic wave absorption sheet 70 are different kinds of electromagnetic wave absorption sheets having different permeabilities.

Of the first electromagnetic wave absorption sheet 60 and the second electromagnetic wave absorption sheet 70, one has higher permeability than the other.

Of the first electromagnetic wave absorption sheet 60 and the second electromagnetic wave absorption sheet 70, the one having higher permeability functions to prevent the performance of the antenna unit for wireless power charging from deteriorating, and the other having relatively low permeability functions to prevent the performance of the antenna unit for near field wireless communication from deteriorating.

The first electromagnetic wave absorption sheet 60 or the second electromagnetic wave absorption sheet 70 may be any one selected from among a carbon nanosheet containing carbon nanotubes or carbon nanoparticles, an amorphous sheet containing an amorphous alloy, a polymer sheet containing a magnetic powder, and a ferrite sheet.

Preferably, the first electromagnetic wave absorption sheet 60 is any one selected from among a carbon nanosheet containing carbon nanotubes or carbon nanoparticles, an amorphous sheet containing an amorphous alloy, a polymer sheet containing a magnetic powder, and a ferrite sheet, and the second electromagnetic wave absorption sheet 70 is any one selected from among a carbon nanosheet containing carbon nanotubes or carbon nanoparticles, an amorphous sheet containing an amorphous alloy, a polymer sheet containing a magnetic powder, and a ferrite sheet, and is a different material than that of the first electromagnetic wave absorption sheet 60.

Preferably, of the first electromagnetic wave absorption sheet 60 and the second electromagnetic wave absorption sheet 70, one is a polymer sheet containing a magnetic powder, and the other is any one selected from among a carbon nanosheet containing carbon nanotubes or carbon nanoparticles, an amorphous sheet containing an amorphous alloy, a polymer sheet containing a magnetic powder, and a ferrite sheet.

The polymer sheet has low manufacturing cost and relatively low permeability compared to the carbon nanosheet, the amorphous sheet, and the ferrite sheet, and may thus be used as a shielding sheet for a wireless communication antenna, thereby reducing the manufacturing cost and the thickness.

The carbon nanosheet may be manufactured by mixing carbon nanotubes or carbon nanoparticles with a resin to prepare a mixture, which is then subjected to thermal treatment, tape casting, drying, and rolling to increase the density thereof.

The carbon nanotubes, having high thermal conductivity and superior electrical conductivity, are responsible for heat dissipation performance as well as electromagnetic wave absorption performance. When the grains contained in the electromagnetic wave absorption sheet are made to have a nano size, the permeability of the electromagnetic wave absorption sheet is increased, thereby enhancing the electromagnetic wave absorption efficiency thereof.

The amorphous alloy may be an ally including a soft magnetic powder having an amorphous structure.

A soft magnetic powder, comprising any one of Fe—Si—B, Fe—Si—B—Cu—Nb, Fe—Zr—B, and Co—Fe—Si—B, may be quenched, yielding an amorphous alloy.

The magnetic powder of the polymer sheet may be a Fe-based magnetic powder.

The first electromagnetic wave absorption sheet 60 or the second electromagnetic wave absorption sheet 70 may be provided in a size corresponding to the wireless power charging antenna pattern 43 disposed at the center of the substrate 45. In this case, the thickness of the entire antenna module 30 may not be uniform, but a significant cost reduction effect may be obtained.

The electromagnetic wave absorption sheet according to the present invention, having a dual structure of the first electromagnetic wave absorption sheet 60 and the second electromagnetic wave absorption sheet 70, causes low manufacturing cost compared to an electromagnetic wave-shielding sheet having a single layer with the same thickness, thus exhibiting a significant cost reduction effect and superior properties. Also, the electromagnetic wave absorption sheet according to the present invention is thinner but can exhibit significantly better electromagnetic wave absorption performance than an electromagnetic wave absorption sheet having a single layer.

The foregoing is shown in Tables 1 to 3 below.

The properties of the antenna module according to embodiments of the present invention, determined through testing, are described below.

Table 1 below shows the structure and specification of an antenna module according to the present invention, and the structure and specification of antenna modules according to comparative examples of the present invention.

As shown in Table 1 below, respective electromagnetic wave absorption sheets of Example and Comparative Examples1 and 2 include the same antenna unit and different configurations.

TABLE 1

| | Antenna unit | | | | Electromagnetic wave | | Total |
|---|---|---|---|---|---|---|---|
| | | | | Adhesive | absorption sheet | | Thickness |
| | FPCB type | WPC | NFC | thickness | Sheet A | Sheet B | (mm) |
| Comp. Ex. 1 | 55 × 45.5 × 0.13 T | Φ39 | 55 × 45.5 | 50 | ARS2 | PC Sheet_0.2 t | 0.53 t |
| | (mm) | mm | mm² | μm | 4N_0.15 t | | |
| Comp. Ex. 2 | | | | | ARS2 | PC Sheet_0.2 t | 0.53 t |
| | | | | | 4N_0.15 t | | |
| Example | | | | | ARS2 | Polymer_0.2 t | 0.47 t |
| | | | | | 2N_0.09 t | | |

In the antenna unit of Table 1, FPCB type is the size of the substrate, WPC is the wireless power charging antenna pattern, NFC is the near field communication antenna pattern, and Adhesive thickness is the thickness of the adhesive layer for bonding the electromagnetic wave absorption sheet.

In Comparative Examples 1 and 2 and Example 2 of Table 1, ARS2 of Sheet A is the kind of amorphous sheet, corresponding to the electromagnetic wave-shielding sheet according to the present invention. In Example of Table 1, Polymer of Sheet B is the kind of polymer sheet, corresponding to the electromagnetic wave-shielding sheet according to the present invention. Furthermore, PC Sheet of Sheet B of Table 1 is the polycarbonate sheet, which is not the electromagnetic wave-shielding sheet but is a typical sheet, and is inserted to adjust the thickness of the sheet in Comparative Examples 1 and 2 and Example of the present invention.

Specifically, Comparative Example 1 is an antenna module including an electromagnetic wave-shielding sheet comprising the amorphous sheet having a single layer with a thickness of 0.15 mm, and Comparative Example 2 is an antenna module including an electromagnetic wave-shielding sheet comprising the polymer sheet having a single layer with a thickness of 0.15 mm. In contrast, Example of the present invention is composed of the amorphous sheet as the first electromagnetic wave absorption sheet 60 and the polymer sheet as the second electromagnetic wave absorption sheet 70, and the total thickness of these two sheets is 0.11 mm, which is thinner than the sheets of Comparative Examples 1 and 2.

Table 2 below shows the wireless power charging efficiencies of the antenna modules of Table 1. FIG. 4 is a graph illustrating the wireless power charging efficiency results of Table 2.

TABLE 2

| | Efficiency Test | | | | |
|---|---|---|---|---|---|
| | (A1 Type, Tx magnet) | | | | |
| | Tx | Tx | Rx | Rx | Efficiency |
| | (mA) | (V) | (mA) | (V) | (%) |
| Comp. Ex. 1 | 260 | 19 | 650 | 4.92 | 64.74 |
| Comp. Ex. 2 | 269 | 19 | 650 | 4.91 | 62.44 |
| Example | 255 | 19 | 650 | 4.92 | 66.01 |

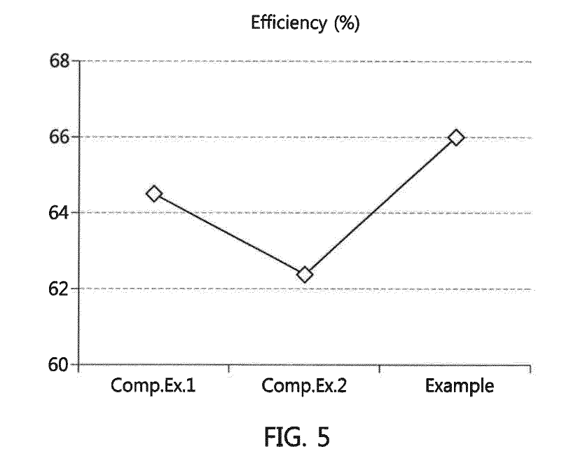

As shown in Tables 1 and 2 and FIG. 5, the electromagnetic wave absorption sheet of Example of the present invention, comprising the amorphous sheet as the first electromagnetic wave absorption sheet 60 and the polymer sheet containing a magnetic powder as the second electromagnetic wave absorption sheet 70, which overlap each other, exhibited the best wireless power charging efficiency, namely 66.01%, compared to the electromagnetic wave-shielding sheet of Comparative Example 1, comprising the amorphous sheet having a single layer, and the electromagnetic wave-shielding sheet of Comparative Example 2, comprising the polymer sheet having a single layer.

Furthermore, the electromagnetic wave-shielding sheet of Example of the present invention, comprising the first electromagnetic wave absorption sheet 60 and the second electromagnetic wave absorption sheet 70, has a thickness of 0.11 mm, but the electromagnetic wave absorption sheets each having a single layer of Comparative Examples 1 and 2 had a thickness of 0.15 mm. Thus, Example of the present invention is thinner than Comparative Examples 1 and 2 but exhibits relatively high wireless power charging efficiency.

Accordingly, in Example of the present invention, the two antenna modules are very thin, as low as 0.47 t, thus resulting in a significant thickness reduction.

Table 3 below shows the properties of the antenna modules of Table 1.

TABLE 3

| | NFC Properties | | | | | | | | |
|---|---|---|---|---|---|---|---|---|---|
| | Communication distance (mm) | | | | | VPP (mV) | | | |
| | C/E Mode | | | | | EMV Load modulation Type A | | | |
| | | VIVO- | Reader Mode | | | (0.0.0) | (1.0.0) | (2.0.0) | 3.0.0) |
| | ACR | pay | 1K | 4K | EV1 | 8.8 mV | 7.2 mV | 5.6 mV | 4 mV |
| Comp. Ex. 1 | 28 | 39 | 30 | 29 | 17 | 41.17 | 30.75 | 14.18 | 4.74 |
| Comp. Ex. 2 | 43 | 43 | 36 | 35 | 19 | 56.32 | 38.41 | 26.54 | 8.38 |
| Example | 42 | 42 | 36 | 36 | 19 | 38.25 | 26.28 | 19.38 | 7.26 |

As is apparent from Tables 1 and 3, the communication distance of Example of the present invention is quite long, compared to Comparative Examples 1 and 2.

Therefore, the formation of the electromagnetic wave absorption sheet having a dual structure by overlapping the first electromagnetic wave absorption sheet 60 and the second electromagnetic wave absorption sheet 70 that are made of different materials can increase the recognition distance, which is required to acquire information.

In the present invention, improved NFC properties and superior wireless power charging performance can be manifested.

According to the present invention, the antenna unit has the wireless communication antenna pattern and the wireless power charging antenna pattern, thereby exhibiting both near field wireless communication performance and wireless power charging performance. The electromagnetic wave absorption sheet can be realized by overlapping the first electromagnetic wave absorption sheet and the second electromagnetic wave absorption sheet, thus simplifying the assembly process, significantly decreasing the defect of an outer appearance, and increasing productivity.

Also, according to the present invention, even when the thickness of the electromagnetic wave absorption sheet is not increased, high electromagnetic wave absorption efficiency can be attained, products can be manufactured to be small and slim, and manufacturing costs can be reduced.

Also, according to the present invention, the first and the second electromagnetic wave absorption sheet have different permeabilities, and can thus absorb the corresponding electromagnetic waves in the frequency ranges of individual patterns, thus improving the operational reliability of the antenna module.

The present invention is not limited to the aforementioned embodiments, but can be variously modified without departing from the spirit of the present invention, which is incorporated in the scope of the present invention.

1. An antenna module, comprising:
an antenna unit;
a first electromagnetic wave absorption sheet disposed on one surface of the antenna unit; and
a second electromagnetic wave absorption sheet disposed on one surface of the first electromagnetic wave absorption sheet such that the second electromagnetic wave absorption sheet at least partially overlaps the first electromagnetic wave absorption sheet.

2. The antenna module of claim 1, wherein the first electromagnetic wave absorption sheet and the second electromagnetic wave absorption sheet have different permeabilities.

3. The antenna module of claim 1, wherein the first electromagnetic wave absorption sheet and the second electromagnetic wave absorption sheet are disposed between the antenna unit and a battery pack of a portable device.

4. The antenna module of claim 1, wherein the antenna unit comprises:
a wireless communication antenna pattern for near field wireless communication;
a wireless power charging antenna pattern for wireless power charging; and
a substrate on which the wireless communication antenna pattern and the wireless power charging antenna pattern are formed.

5. The antenna module of claim 1, wherein the first electromagnetic wave absorption sheet and the second electromagnetic wave absorption sheet are laminated in a manner such that an entire surface of one is covered with an entire surface of the other.

6. The antenna module of claim 1, wherein the first electromagnetic wave absorption sheet and the second electromagnetic wave absorption sheet have the same size and are disposed so as to completely overlap each other.

7. The antenna module of claim 1, wherein, of the first electromagnetic wave absorption sheet and the second electromagnetic wave absorption sheet, one functions to increase wireless recognition performance, and the other functions to increase wireless power charging performance.

8. The antenna module of claim 1, wherein the first electromagnetic wave absorption sheet or the second electromagnetic wave absorption sheet is any one selected from among a carbon nanosheet containing carbon nanotubes or carbon nanoparticles, an amorphous sheet containing an amorphous alloy, a polymer sheet containing a magnetic powder, and a ferrite sheet.

9. The antenna module of claim 1, wherein the first electromagnetic wave absorption sheet is any one selected from among a carbon nanosheet containing carbon nanotubes or carbon nanoparticles, an amorphous sheet containing an amorphous alloy, a polymer sheet containing a magnetic powder, and a ferrite sheet, and
the second electromagnetic wave absorption sheet is any one selected from among a carbon nanosheet containing carbon nanotubes or carbon nanoparticles, an amorphous sheet containing an amorphous alloy, a polymer sheet containing a magnetic powder, and a ferrite sheet, and is different from a material of the first electromagnetic wave absorption sheet.

10. The antenna module of claim 1, wherein, of the first electromagnetic wave absorption sheet and the second electromagnetic wave absorption sheet, one is a polymer sheet containing a magnetic powder, and the other is any one selected from among a carbon nanosheet containing carbon nanotubes or carbon nanoparticles, an amorphous sheet containing an amorphous alloy, a polymer sheet containing a magnetic powder, and a ferrite sheet.

11. An electromagnetic wave absorption sheet, comprising:
a first electromagnetic wave absorption sheet; and
a second electromagnetic wave absorption sheet disposed on one surface of the first electromagnetic wave absorption sheet such that the second electromagnetic wave absorption sheet at least partially overlaps the first electromagnetic wave absorption sheet.

12. The electromagnetic wave absorption sheet of claim 11, wherein the first electromagnetic wave absorption sheet and the second electromagnetic wave absorption sheet have different permeabilities.

13. The electromagnetic wave absorption sheet of claim 11, wherein the first electromagnetic wave absorption sheet and the second electromagnetic wave absorption sheet are laminated in a manner such that an entire surface of one is covered with an entire surface of the other.

14. The electromagnetic wave absorption sheet of claim 11, wherein the first electromagnetic wave absorption sheet and the second electromagnetic wave absorption sheet have the same size and are disposed so as to completely overlap each other.

15. The electromagnetic wave absorption sheet of claim 11, wherein the first electromagnetic wave absorption sheet or the second electromagnetic wave absorption sheet is any one selected from among a carbon nanosheet containing carbon nanotubes or carbon nanoparticles, an amorphous sheet containing an amorphous alloy, a polymer sheet containing a magnetic powder, and a ferrite sheet.

16. The electromagnetic wave absorption sheet of claim 11, wherein the first electromagnetic wave absorption sheet is any one selected from among a carbon nanosheet containing carbon nanotubes or carbon nanoparticles, an amorphous sheet containing an amorphous alloy, a polymer sheet containing a magnetic powder, and a ferrite sheet, and the second electromagnetic wave absorption sheet is any one selected from among a carbon nanosheet containing carbon nanotubes or carbon nanoparticles, an amorphous sheet containing an amorphous alloy, a polymer sheet containing a magnetic powder, and a ferrite sheet, and is different from a material of the first electromagnetic wave absorption sheet.

17. The electromagnetic wave absorption sheet of claim 11, wherein, of the first electromagnetic wave absorption sheet and the second electromagnetic wave absorption sheet, one is a polymer sheet containing a magnetic powder, and the other is any one selected from among a carbon nanosheet containing carbon nanotubes or carbon nanoparticles, an amorphous sheet containing an amorphous alloy, a polymer sheet containing a magnetic powder, and a ferrite sheet.
